(19) United States
(12) Patent Application Publication
(10) Pub. No.: US 2006/0018045 A1
(43) Pub. Date: Jan. 26, 2006

(54) Mirror arrangement and method of manufacturing thereof, optical system and lithographic method of manufacturing a miniaturized device

(75) Inventors: Timo Moeller, Westhausen (DE); Martin Ross-Messemer, Essingen (DE); Frank Hoeller, Aalen (DE); Sascha Bleidistel, Aalen (DE)

Correspondence Address: JONES DAY, 2882 SAND HILL ROAD, SUITE 240, MENLO PARK, CA, 94025, US

(73) Assignee: Carl Zeiss SMT AG, Oberkochen (DE)

(21) Appl. No.: 10/971,002

(22) Filed: Oct. 25, 2004

(30) Foreign Application Priority Data
Oct. 23, 2003 (DE) 103 49 290.9

(51) Int. Cl. G02B 5/08

(52) U.S. Cl. 359/838

(57) ABSTRACT

A mirror arrangement for reflecting electromagnetic radiation, the mirror arrangement comprising: a substrate having a mirror side facing towards the radiation to be reflected and a back side opposite to the mirror side, wherein a mirror surface is provided on the mirror side and wherein an actuator arrangement for generating a deformation of the substrate is mounted on the back side of the substrate, wherein the actuator arrangement comprises at least one active layer having an areal adhering contact with a portion of the back side of the substrate; wherein the at least one active layer has a first layer thickness at a first location within the portion and a second layer thickness at a second location disposed at a distance from the first location within the portion, wherein the first layer thickness differs from the second layer thickness by more than 1%; and wherein the at least one active layer comprises at least one of a ferroelectric material, a piezoelectric material, a magnetostrictive material, an electrostrictive material and a memory metal alloy.

### BACKGROUND OF THE INVENTION

1. Field of the Invention

The present disclosure relates to a mirror arrangement for reflecting electromagnetic radiation, and to a method for manufacturing such a mirror arrangement. The present disclosure further relates to an optical system having a mirror arrangement and to a lithographic method of manufacturing a miniaturized device using a projection exposure system.

2. Brief Description of Related Art

A mirror arrangement has a mirror surface the geometry of which determines the optical properties of the mirror. The mirror arrangement can be integrated within an optical system and determine a path of rays therein. In particular, the optical system may comprise a projection optical system as it is used in lithographical methods for imaging a reticle onto a photosensitive layer for manufacturing of miniaturized components.

A success of such optical systems depends among other things on the precision in which the shape of the mirror surface of the mirror arrangement matches a predefined shape of the mirror surface.

From U.S. Pat. No. 5,986,795 a mirror arrangement is known the mirror surface of which is deformable to form the optical properties of the mirror variably and to particularly be able to adapt these to desired optical properties. According to this the mirror arrangement of the art comprises a substrate having a mirror side facing towards the radiation to be reflected, where a mirror surface is provided and a back side facing away from the mirror side. Further, a reaction plate is arranged in a distance apart from the back side and between the substrate and the reaction plate a plurality of actuators arranged with a distance from each other is provided, which actuators are hold with one end to the substrate and with the other end to the reaction plate. By operation of the actuators it is possible to deform the substrate and by this the mirror surface in a predefined manner. Concerning the arrangement of the art it is further provided to keep the layer thickness of the substrate and the thickness of the reaction plate over the cross section of the mirror surface not constant but to design the thicknesses variably in order to manipulate the bending characteristics of the substrate.

The arrangement of the related art is complicated with respect to its assembly having a plurality of actuators and with respect to the control of the actuators during operation.

It is further known to provide deformable mirror arrangements by applying a piezoelectric layer onto a back side of a substrate providing a mirror surface. By triggering of a piezoeffect in such a layer consequently the mirror surface is deformable. Nevertheless a bending characteristics of the mirror surface cannot be adapted to a desired characteristic.

### SUMMARY OF THE INVENTION

The present invention has been accomplished taking the above problems into consideration.

It is an object of the present invention to provide a mirror arrangement having a deformable mirror surface and which is adaptable to a desired characteristic with respect to a bending characteristic of the mirror surface on operation of an actuator.

Further it is an object of the present invention to provide an optical system having the aforementioned mirror arrangement.

Still further it is an object of the present invention to provide a lithographic method of manufacturing a miniaturized device using a projection exposure system.

In order to achieve such object, the present invention provides a mirror arrangement for reflecting electromagnetic radiation, the mirror arrangement comprising a substrate having a mirror side facing towards the radiation to be reflected and a back side opposite to the mirror side, wherein a mirror surface is provided on the mirror side and wherein an actuator arrangement for generating a deformation of the substrate is mounted on the back side of the substrate, wherein the actuator arrangement comprises at least one active layer having an areal adhering contact with a portion of the back side of the substrate.

The at least one active layer has a first layer thickness at a first location within the portion and a second layer thickness at a second location disposed at a distance from the first location within the portion, wherein the first layer thickness differs from the second layer thickness by more than 1%. Because of the locally different layer thicknesses of the active layer the actuator provides locally different operational forces for deformation of the substrate. By an appropriate selection of the layer thickness distribution of the active layer on the substrate it is thereby possible to set a distribution of deformation force of the actuator on the substrate.

Between the two locations being disposed within a distance from each other the layer thickness changes preferably continuously and continually. In particular the active layer can be made from a material which comprises a ferroelectric material, a piezoelectric material, a magnetostrictive material, an electrostrictive material and a memory metal alloy.

According to one embodiment of the invention the layer thicknesses at the both locations differ by more than 1%. Further the layer thicknesses can have bigger differences at the both locations. As for example 2%, 3%, 4%, 5%, 6%, 7%, 8%, 9% ore more.

According to a further embodiment of the invention the at least one active layer has a rotational symmetric distribution of layer thickness with respect to an axis of symmetry. According to an alternative embodiment the distribution of layer thickness of the active layer is rotationally unsymmetric; which is, at all locations within the portion, rotationally non-symmetric with respect to all lines extending through each respective location.

According to a further embodiment of the invention the distribution of the layer thickness is substantially representable by one single Zernike polynomial. With such a distribution of layer thickness it is possible to set wavefront variations using the mirror surface which also correspond to the corresponding Zernike polynomial, when the mirror stands in the pupil, respectively, correspond to polynomials, which are determined by the position of the mirror and by the transfer behaviour of the optical system. Such wavefront variations are desired in optical systems for further compensation of aberrations. In alternative for the description of the distribution of the layer thickness based on Zernike polynomials also other appropriate functional systems are possible as for example splines, Tschebyscheff polynomials, modular descriptions, free surface forms.

According to a further embodiment of the invention the substrate has a first substrate thickness at the first location within the portion and a second substrate thickness at the second location within the portion, and wherein the first substrate thickness differs from the second substrate thickness by more than 1%. Also bigger differences as for example 2%, 3%, 4%, 5%, 6%, 7%, 8%, 9%, 10%, 11%, 12%, 13%, 14% or more are provided.

According to an embodiment the actuator arrangement comprises one single active layer, wherein the areal adhering contact of the active layer with the portion of the back side of the substrate is mediated by an intermediate adhesion layer firmly joining the active layer to the back side of the substrate. The intermediate adhesion layer can comprise an adhesive, a solder, an eutecticum, a paste and other layers. According to an embodiment the adhesion mediation layer also provides an electrode layer for exciting the active layer. According to an alternative embodiment an electrode layer is a supplement to the adhesion mediation layer as a further layer arranged between the active layer and the substrate. According to an embodiment of the invention the electrode layer continuously extends over the portion of the back side of the substrate.

According to an embodiment of the invention the actuator arrangement comprises a plurality of active layers which are stacked one above the other, wherein each pair of active layers are joined to each other by an areal adhering contact.

According to an embodiment of the invention the mirror arrangement comprises a bottom layer of the plurality of active layers and arranged closest to the substrate, wherein the areal adhering contact of the bottom active layer with the portion of the back side of the substrate is mediated by an intermediate adhesion layer firmly joining the active layer to the back side of the substrate. According to an embodiment of the invention an electrode layer for exciting the active layer is disposed between the bottom active layer and the substrate. According to an embodiment of the invention the electrode layer comprises the adhesion mediating layer.

According to an embodiment of the invention at least one electrode layer for exciting at least one active layer of a pair of adjacent layers is disposed between said pair of adjacent active layers. According to an embodiment of the invention the electrode layer continuously extends over the portion of the back side of the substrate.

According to an alternative embodiment of the invention the electrode layer comprises a plurality of non-overlapping partial electrodes, distributed over the portion of the back side of the substrate. According to a further embodiment of the invention first and second partial electrodes of each pair of partial electrodes are electrically insulated from each other. Still further according to an embodiment of the invention an electrical resistance between first and second partial electrodes of each pair of partial electrodes is greater than 1 M Ω. According to an exemplary embodiment the plurality of partial electrodes are arranged in a hexagonal pattern. The plurality of partial electrodes is groupable into electrode groups, wherein the electrode groups are arranged in a hexagonal pattern.

The invention further provides a method of manufacturing a mirror arrangement for reflecting electromagnetic radiation, wherein the method comprises:
applying a paste of a precursor material to a back side of a substrate and distributing the precursor material on the back side to form a layer such that the layer has a first layer thickness at a first location and a second layer thickness at a second location disposed at a distance from the first location, wherein the first layer thickness differs from the second layer thickness by more than 1%;
sintering the layer of the precursor material to form an active layer; and
providing a mirror surface on a front side opposite to the back side of the substrate.

According to an exemplary embodiment the distributing of the precursor material comprises rotating of the substrate about an axis of rotation. The rotating proceeds such that the precursor material distributes according to an equilibrium between the centripetal force and the gravitational force at the different locations of the precursor material. Also a viscosity of the precurser material can provide a force affecting the shape of the surface, the layer thicknesses respectively.

According to another embodiment the distributing of the precursor material comprises pressing a shaped stamp into the layer to shape the layer according to a surface shape of the stamp. By this also the desired layer thicknesses distribute according to the shape of the surface shape of the stamp. According to an exemplary embodiment the surface shape of the stamp comprises at least one of a concave portion and a convex portion. According to another exemplary embodiment the surface shape of the stamp comprises at least one of plural concave portions and plural convex portions.

The invention further provides an optical system having a plurality of optical elements, wherein at least one of the optical element comprises a mirror arrangement as described above.

According to another embodiment of the invention an optical system is provided, the optical system having a plurality of optical elements, wherein at least one of the optical elements comprises a mirror arrangement for reflecting electromagnetic radiation, wherein the mirror arrangement comprises a substrate having a mirror side facing towards the radiation to be reflected and a back side opposite to the mirror side, wherein a mirror surface is provided on the mirror side and wherein an actuator arrangement for generating a deformation of the substrate is mounted on the back side of the substrate, wherein the actuator arrangement comprises at least one active layer having an areal adhering contact with a portion of the back side of the substrate; wherein the at least one active layer has a first layer thickness at a first location within the portion and a second layer thickness at a second location disposed at a distance from the first location within the portion, wherein the first layer thickness differs from the second layer thickness by more than 1%; and wherein the at least one active layer comprises at least one of a ferroelectric material, a piezoelectric material, a magnetostrictive material, an electrostrictive material and a memory metal alloy.

According to another embodiment of the invention the optical system can also be a catadioptrical system wherein at least one of the optical elements comprises a refractive lens. In an alternative embodiment the optical system comprises only mirrors as the optical elements.

According to another embodiment of the invention the optical system further comprises a mount for mounting a patterning structure to be imaged in a region of an object plane of the optical system, and a mount for mounting a substrate having a radiation sensitive layer in an image plane of the optical system.

According to an embodiment the optical system comprises an objective of a lithographic system for imaging a pattern forming structure (reticle) onto a photosensitive layer (resist), which is provided on a substrate (wafer).

According to another embodiment of the invention lithographic method of manufacturing a miniaturized device using a projection exposure system optical system is provided, wherein the method comprises: disposing a patterning structure to be imaged in a region of an object plane of an imaging optics of the projection exposure system; disposing a substrate carrying a resist in a region of an image plane of the imaging optics and exposing portions of the substrate with images of the patterning structure using the projection exposure system; wherein the projection exposure system comprises a plurality of optical elements, and wherein at least one of the optical elements comprises a mirror arrangement as described above.

### BRIEF DESCRIPTION OF THE DRAWINGS

The forgoing as well as other advantageous features of the invention will be more apparent from the following detailed description of exemplary embodiments of the invention with reference to the accompanying drawings, wherein

FIG. 1,

FIG. 2,

FIG. 3,

FIG. 4, and

FIG. 5 respectively show an embodiment of a mirror arrangement according to the invention;

FIGS. 6a-6d,

FIG. 7, and

FIG. 8 show steps of manufacturing of mirror arrangements;

FIG. 9a and

FIG. 9b show lines of height of a thickness distribution of an active layer according to further embodiments of mirror arrangements according to the present invention;

FIG. 10 shows a further embodiment of a mirror arrangement according to the present invention with a plurality of active layers;

FIG. 11 shows an example for a pattern of partial electrodes for the exciting the active layer according to a mirror arrangement according to the present invention;

FIG. 12 shows an optical system according to an embodiment of the present invention; and

FIG. 13 shows a further projection exposure system optical system for manufacturing a miniaturized device according to an embodiment of the present invention.

It is noted that not all possible embodiments of the present invention necessarily exhibit each and every, or any, of the advantages described herein.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

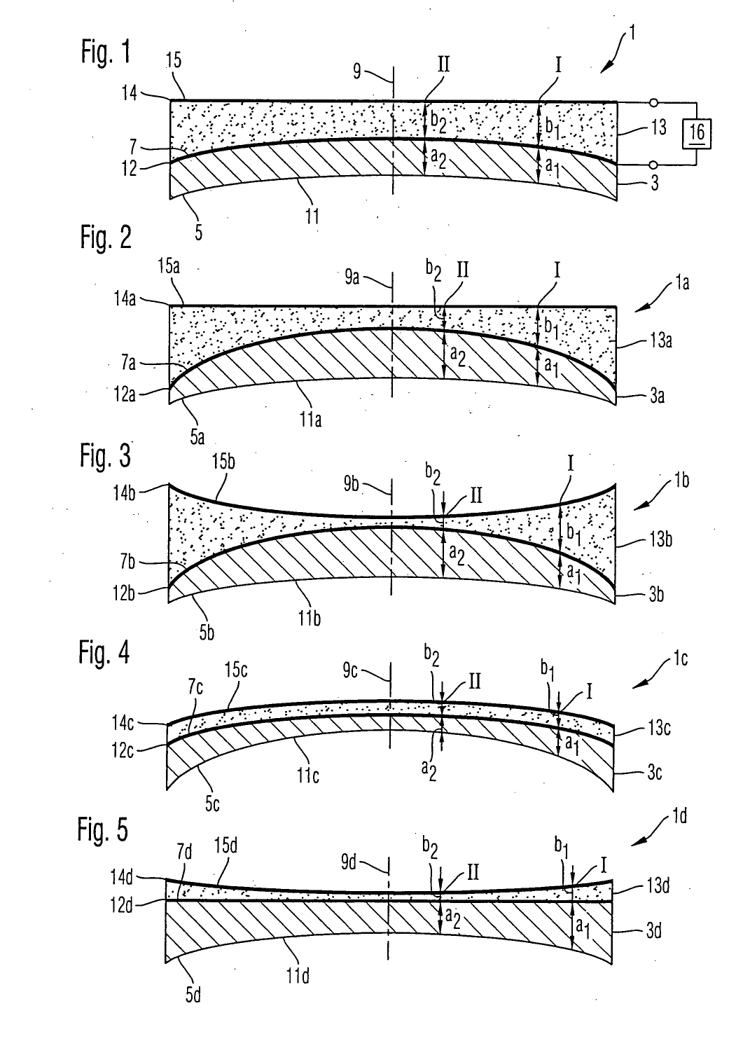

In FIG. 1 an embodiment of a mirror arrangement 1 is illustrated schematically in a section. The mirror arrangement 1 comprises a substrate 3 made of a glass material, as for example Zerodur, which has a small coefficient of thermal expansion. Also any other appropriate substrate can be used as for example a substrate made of silicon. The glass substrate 3 has a front side 5 and a back side 7. The front side 5 and the back side 7 are in their form rotational symmetric with respect to an axis 9. The front side 5 bears a mirror surface 11, i.e. the surface which determines the optical properties of the mirror arrangement 1. For this the front side 5 of the substrate 3 can be metallized in order to provide a metallically reflecting mirror surface 11. It is also possible to provide the front side 5 with several layers of a dielectric medium, in order to provide the mirror surface 11 by a layered structure.

The back side 7 of the substrate 3 is firmly joint to the active layer 13 made of a piezomaterial as for example lead-circonate-titanate (PZT). Also the layer 13 made of piezomaterial is rotationally symmetric with respect to axis 9, wherein the back side 0.15 facing away from the substrate is a flat surface.

The front side 5 of the substrate 3, respectively, the mirror surface 11 has a concave parabolic shape. The back side 7 of the substrate 3 exhibits a similar form so that the substrate exhibits a same thickness (a₁, a₂) at each location on the substrate.

Nevertheless a layer thickness of layer 13 made of piezomaterial is dependent on location. It thus exhibits at a location I, a thickness b₁ which is greater than a thickness b₂ at a location II.

For the operation of the layer 13 as actuator an electrical potential generated by a controlled voltage supply 16 is applied to an electrode 12 provided between the substrate 3 and the layer 13 and to a further electrode 14 provided at a back side 15 of the layer 13, so that based on the piezoelectrical effect in layer 13 this layer generates a mechanical force which leads to deformation of the substrate as well as the mirror surface 11. In the illustrated exemplary embodiment the electrodes 12 and 14 are area electrodes extending continuously over the whole surface of the active layer 13. The electrode 12 by this forms also a intermediate adhesion layer between the substrate 3 and the active layer 13. For this the electrode 12, the intermediate adhesion layer, respectively, can be formed by a gold paste.

This deformation is determined by the thickness and rigidity of the substrate 3, the thickness and rigidity of the layer 13 made of piezomaterial and the location dependency of the layer thickness of the layer 13. Depending on the location dependent layer thickness of layer 13 the location dependency of the piezo force is determined.

In the following further variants of the embodiment illustrated in FIG. 1 will be described. Concerning this, components which correspond with respect to their function or their structure with components of FIG. 1 are provided with the same reference numerals as in FIG. 1, but are supplemented for the reason of differentiation with a letter.

The mirror arrangement 1a shown in FIG. 2 differs from the mirror arrangement in FIG. 1 in that the substrate 3a also exhibits a location dependent layer thickness. So, thicknesses of the substrate a₁, a₂, respectively at two locations I and II are different.

The geometrical relations of the mirror arrangement in FIG. 2 and also in the other figures are shown schematically only and do not provide conclusions on real existing geometries. Particularly curvatures of the individual surfaces of the mirror arrangement, as for example 11a, 7a and 15a are illustrated exaggerated. Realistic values for dimensions of the mirror arrangement are given exemplarily for the mirror arrangement 1a, shown in FIG. 2: 50 mm<r<500 mm; a₁>a₂/2, a₂>r/10, in particular a₂>r/5 and further preferred a₂>r/2.5; b₁<0.5 mm; b₁>b₂>0.05 mm, wherein the location I has a distance 0.75 r from the axis 9a and the location II has a distance r/4 from the axis 9a, wherein r is a radius with respect to the axis 9a.

The mirror arrangement 1b shown in FIG. 3 differs from the mirror arrangement 1a shown in FIG. 2 substantially in that the back side 15b of the layer 13b made of piezomaterial is not a planar surface but a concave surface. By this the location dependency of the layer thickness of layer 13b is further enhanced. At location I the thickness b₁ of the layer 13b is considerably larger than at location II.

Concerning the mirror arrangement 1c shown in FIG. 4 the layer thickness of the substrate 3c is location dependent and at a location I lying with respect to the axis 9c radially outside bigger than at a radially inner lying location II. The layer thickness of layer 13c made of piezomaterial however is substantially constant.

The mirror arrangement id shown in FIG. 5 differs from the mirror arrangement 1a shown in FIG. 2 substantially in that the back side 7d of the layer 3d is a planar surface and the back side 15d of the layer 13d made of piezomaterial is not a planar surface.

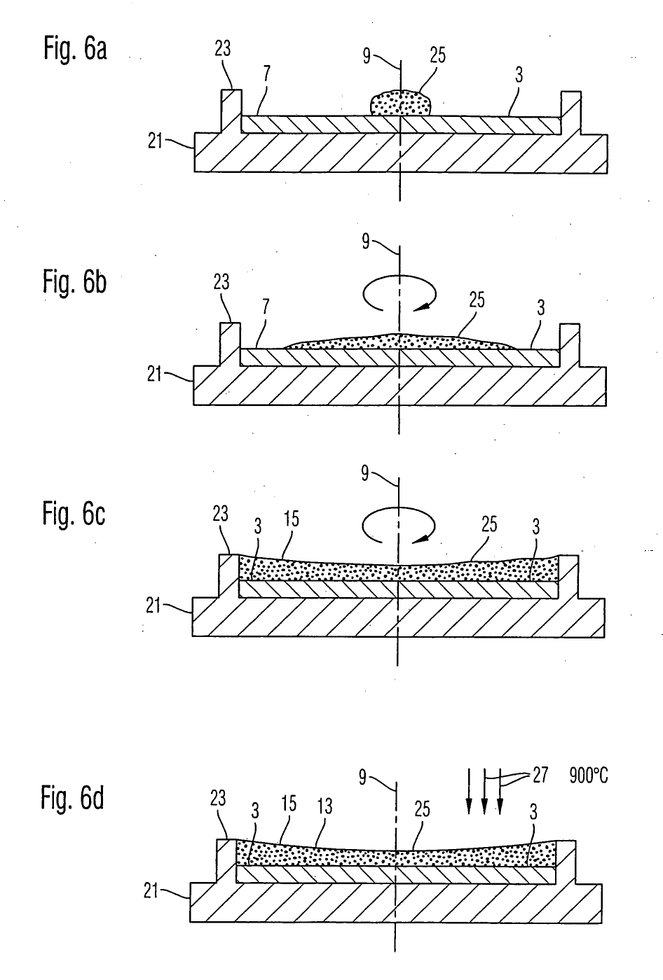

FIG. 6 explains a process for the manufacturing of a mirror arrangement wherein for example the mirror arrangements shown in FIG. 1 to 5 are manufacturable by the process explained according to FIG. 6.

The process uses a mould 21 into which at the beginning of the process (FIG. 6a) the substrate 3 will be inserted. The mould is rotatable round an axis 9 and has an annular wall 23.

Onto the back side 7 of the substrate 3 a piece 25 of PZT-paste, the precursor material of the piezoelectric layer 13 to be produced, will be applied. Then the form 21 will be put into rotation around the axis 9, so that the piece 25 of PZT-paste spreads on the back side 7 of the substrate 3 (FIG. 6b). Then the PZT-paste 25 covers the whole back side 7 of the substrate 3 and impinges to the inner side of the wall 23 of the form 21 (FIG. 6c). After some time the surface 15 of the PZT-paste 25 will acquire a stable concave surface, the geometry of which is determined by an equilibrium between the centripetal force caused by the rotation acting on the PZT-paste 25 which centripetal force tries to drive the PZT-paste radially to an outer side thus enlarging the layer thickness of the paste on the substrate 3 radially outside, and the gravitational force which acts opposite to the enlargement of the layer thickness of the PZT-paste 25 radially outside. The form of the surface 15 will after some time acquire a parabolic form.

Then the PZT-paste 25 is heated (arrows ˜27 in FIG. 6d represent heat radiation) so that the PZT-paste 25 solidifies within the following sintering process and finally forms the layer 13 made of piezomaterial of the mirror arrangement to be manufactured. The piezoelectric layer 13 by this has a location dependent distribution of layer thickness which in the present example is determined by the planar form of the back side 7 of the substrate 3 and by the co-working of centripetal force and gravitational force at rotation. The form of the back side 7 however can also be concave or convex.

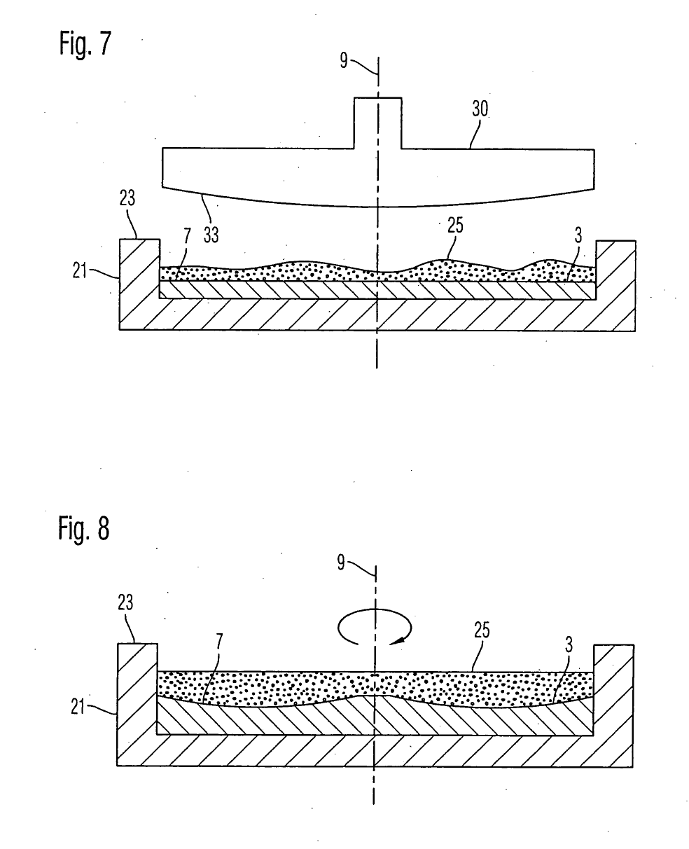

FIG. 7 shows a further embodiment of the method of manufacturing a piezoelectric layer with location dependent layer thickness. For this the substrate 3 again is arranged in a form 21 with an annular wall 23. On the back side 7 of the substrate 3 the pasty precursor material is distributed for forming the piezoelectric layer. A stamp 30 having a predetermined geometrically shaped surface 33 fits into the form and is pressed into it in order to form the shape of the PZT-paste. This will be sintered afterwards.

According to a further embodiment of the method of manufacturing a piezoelectric layer a so-called Mandrel technique is employed. A polished and with gold (Au) vapor-deposited stamp 30 having a predetermined geometric shape of a stamp surface 33 fits into the form and is pressed into the latter such forming the shape of the PZT-paste 25. Thereafter the PZT-paste 25 is sintered at temperatures in a range of 400° C. to 900° C. In the subsequent process of cooling the vapor-deposited gold peels from stamp 30 and remains at the PZT-layer 25 because a coefficient of thermal expansion of the stamp 30 is considerably larger than a coefficient of thermal expansion of the PZT-layer 25. A temperature at which such peeling takes place can be determined empirically. In the vicinity of the peeling temperature a temperature cooling speed, with which the stamp and the sintered layer are being cooled during a process of cooling, is reduced essentially so that internal tensions in the arrangement distribute as even as possible.

FIG. 8 shows a further variation for the manufacturing of a mirror arrangement which works in a similar way as the variation explained using FIG. 5. Here, the back side 7 of the substrate 3, is not formed as a planar surface but as a concave annular surface, so that the substrate 3 exhibits a location dependent thickness. By rotation around an axis of symmetry 9 of the substrate 3 again a pasty precursor material for the piezoelectric layer is distributed on the back side of the substrate 3.

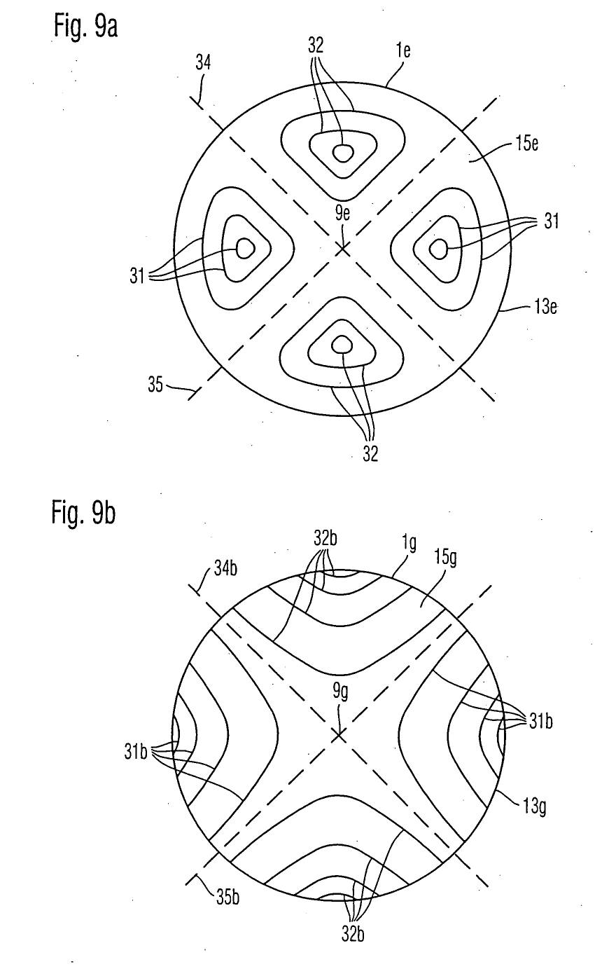

FIG. 9a shows a top view onto an active layer 15e of a mirror arrangement 1e. Here, the lines 31 and 32 represent lines of height of a distribution of layer thickness of the active layer. Differently from the embodiments explained above the distribution of layer thickness of the active layer 13e of the mirror arrangement 1e is not rotational symmetric to an axis. Rather the lines of height 31 represent a reduced layer thickness of the active layer and the lines of height 32 represent a enlarged layer thickness of the active layer. By this a symmetry of the distribution of thickness is a two-fold symmetry around an axis 9e, wherein main axis of this symmetry in FIG. 9a are provided with the reference numerals 35 and 34. The distribution in thickness represented by the lines of height 31, 32 correspond to a Zernike-polynomial Uₙₘ with n=4 and m=1. Another distribution of layer thickness of an active layer 15g is shown in FIG. 9b. Here, similar as described above, the lines 31b and 32b represent lines of height of a distribution of layer thickness of the active layer 13g. The lines of height 31b represent a reduced layer thickness of the active layer and the lines of height 32b represent an enlarged layer thickness of the active layer. By this a symmetry of the distribution of thickness is a two-fold symmetry around an axis 9g, wherein main axes of this symmetry are provided with the reference numerals 35b and 34b in FIG. 9b. The distribution in thickness represented by the lines of height 31b, 32b corresponds to a Zernike polynomial Uₙₘ with n=2 and m=0. Background information concerning Zernike polynomials can be taken, e.g., from the book “Optical Shop Testing” from Daniel Malacara, 2^{nd} Edition, John Wiley & Sons, Inc. 1992. The above selected notation Uₙₘ corresponds to the notation of the book of Malacara.

Such a distribution of layer thickness generates, with a corresponding excitation of the active layer, a deformation of the mirror surface which again is representable by a Zernike polynomial, so that also wavefronts of the light being reflected from the mirror surface suffer an according deformation in the wavefront. The deformation generated by the mirror surface of the mirror arrangement 1e can thus serve for the specific generation or compensation of an astigmatism in an optical system.

The distribution in layer thickness of the active layer as explained according to FIG. 9a can for example be generated using the process explained according to FIG. 7, if the stamp surface 33 is manufactured in advance having a surface shape which corresponds to the desired distribution in layer thickness of the active layer.

The distribution in layer thickness as explained according to FIG. 9 is only exemplary. Also other distributions in thickness can be chosen, which correspond to other Zernike polynomials. Further, also distributions in layer thickness of complete other form and nature can be used.

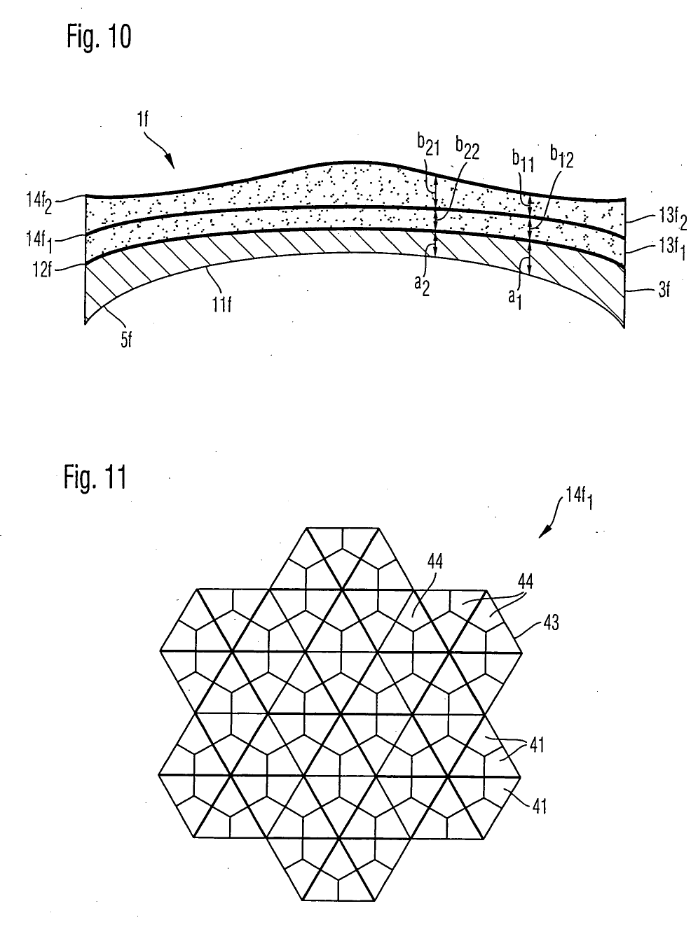

FIG. 10 shows a section corresponding to FIG. 1 to 5 through a mirror arrangement 1f having two active layers 13f₁ and 13f₂ which are applied one above the other on a substrate 3f which provides a mirror surface 11f. Between the substrate 3f and the active layer 13f a passing through electrode 12f is provided, between the active layers 13f₁ and 13f₂ a structured electrode 14f₁ is provided in order to excite the active layer 13f₁ by potential differences between the electrode 12f and the partial electrodes of the electrode layer 14f₁. On the active layer 13f₂ an electrode layer 14f₂ structured into partial electrodes is applied in order to excite the active layer 13f₂ by potential differences between the partial electrodes of the electrode layer 14f₂ and the partial electrodes of the electrode layer 14f₁.

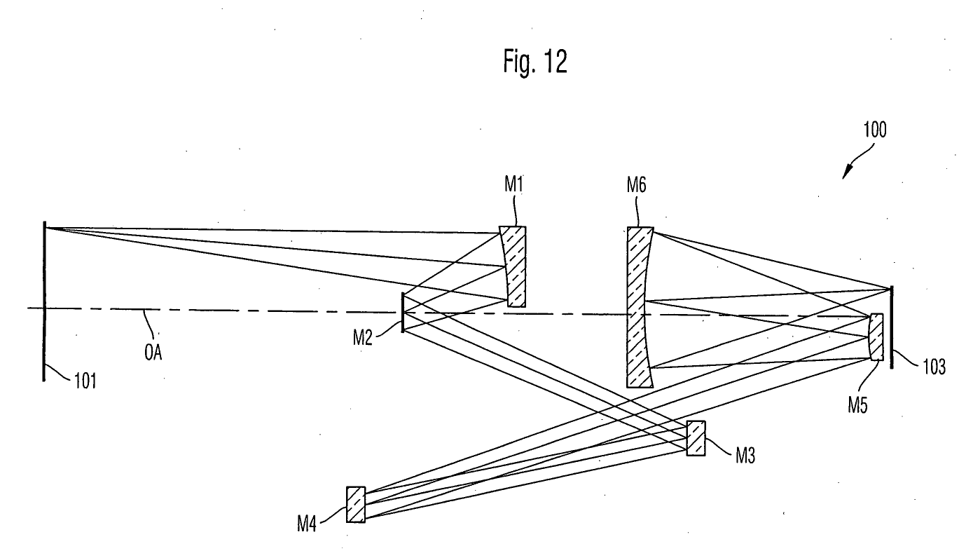

A structure of the electrode layer 14f₁ is schematically illustrated in FIG. 11. The electrode layer 14f₁ comprises a plurality of partial electrodes 41 which are electrically isolated from each other and which can, independently from each other, be provided with an electrical potential by a control not shown in FIGS. 10 and 11. The pattern the partial electrodes 41 are arranged in is structured as follows: eighteen partial electrodes can be grouped to one hexagon 43. The hexagons 43 are arranged as a regular hexagonal pattern in the area. Each hexagon 43 is separable into six uniform triangles 44, wherein each of the triangles contains three partial electrodes 41 which exhibit the form of a kite quadrangle. It has been found that the design of the electrode layer forming the described pattern of partial electrodes is particularly advantageous for the control of the deformation of the mirror surface. By the possibility to control the partial electrodes independent from each other an additional agree of freedom is given for adjusting desired deformations of the mirror surface.

FIG. 12 shows an optical system 100 which images a reticle being arranged within an object plane 101 onto one wafer being arranged within an image plane 103 of the optical system 100. The optical system is a pure reflective optical system with plural mirrors M1, M2, M3, M4, M5, and M6, thus providing a path of rays of the system. Here, the mirror M6 is a mirror with a deformable surface, wherein an actuator of the mirror M6 comprises an active layer made of piezomaterial which exhibits a non-constant distribution of layer thickness.

Background information for the optical system shown in FIG. 12 can be obtained by the EP 0 779 528 A2.

Besides the employment of the deformable mirror in a pure reflective optical system also an employment of the deformable mirror is provided in a katadioptrical system. Background information concerning katadioptrical imaging systems can for example be obtained from U.S. Pat. No. 6,229,647 B1 and EP 1069448 B1. By this it is possible to provide the deformation of the mirror surface such that the wavefront deviations are generated by the deformation are representable by Zernike polynomials. In this case the deformable mirror is particularly well suited for the compensation of aberrations of the optical system. But it is also possible to provide deformations of the mirror surface deviating from the latter. Examples for this are compensations of non-homogeneous heat transfers into the mirror caused by radiation. Then the distribution of layer thickness of the active layer is preferably adjusted such that it is adjusted to the location dependent heat transfer caused by radiation that provided an according control of the actuators a deformation caused by the heat absorption is compensable. Also other effects induced by radiation as for example Compaction, Lens Heating or similar is thus compensable.

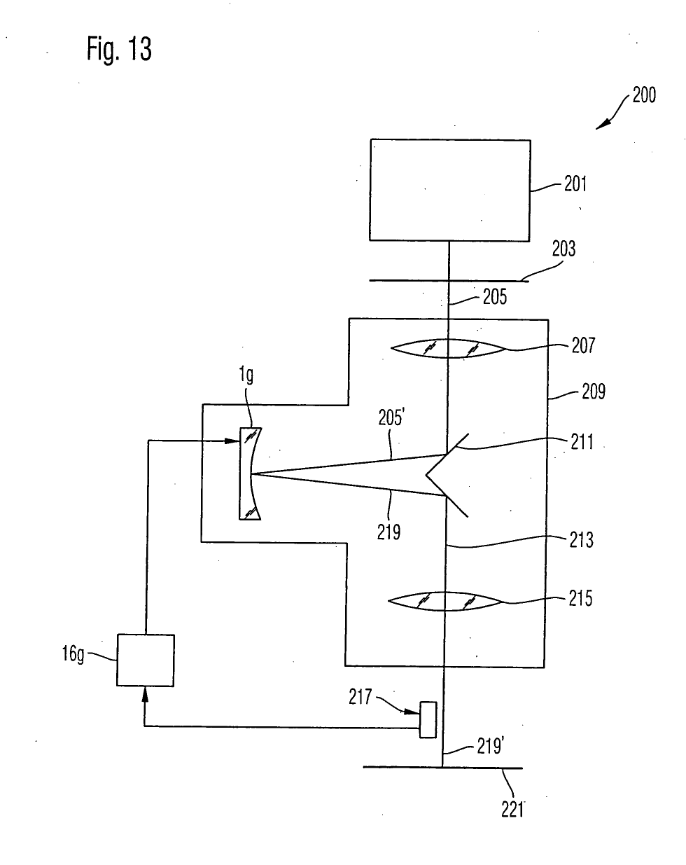

An example for an exemplary embodiment of the mirror arrangement of the present invention is explained in FIG. 13, illustrating a projection exposure system as being used for manufacturing a miniaturized device in lithographic processes. A projection exposure system 200 comprises an illumination means 201, a projection optic 209, a control means 16g, a sensor 217, and an image forming reticle 203 a substrate with a photosensitive layer or wafer 221. The illumination means 201 illuminates the reticle 203 so that a beam 205 passing through the reticle according to the pattern of the reticle is formed in the projection optic 209 by at least one lens 207 such that it impinges onto a mirror 211 will be reflected from this mirror into a ray 205′ and eventually impinges onto the mirror arrangement 1g according to the present invention. The mirror arrangement according to the present invention forms the beam 205′ at an adjusted deformation of the mirror surface as described above and reflects it such that it impinges as beam 219 onto the mirror 211. This will be reflected from the mirror 211 onto at least one lens 215 which forms the beam 219′ and lets it leave the projection optic 209 in order to image the reticle 203 onto the surface of the wafer 221. For the control of the mirror arrangement according to the present invention a schematically sketched sensor 217 is provided which senses deviations of wavefronts of a beam emerging from the projection optic with respect to a set-shape of these wave fronts. According to the sensed wavefront deviations a control 16g controls the mirror arrangement 1g having the active layer by setting appropriate voltages in order to reduce the wavefront deviations.

In order to adjust the form of the piezoelectric layer of the above explained embodiment according to FIG. 6 or 8 as precise as possible an angular speed minor ω should be maintained as exactly as possible when rotating the form so that deviations Δω of the rotational velocity are small, for example Δω/ω≦10⁻⁸. For this a varnish centrifuge can be used as is employed for the coating of semiconductor wafers with photoresists.

Besides the application of the piezomaterial as precursor material onto the substrate it is also possible to apply piezoceramics directly onto the substrate (direct application). It is also possible to provide adhesion mediation between the substrate and the piezolayer as for example pastes particularly a gold paste, and adhesive or a solder. The piezolayer can also be formed by grinding. The grinding can be conducted on the accomplished ceramics or a green mood of the same. The piezoceramics can be formed by any production process for ceramics as for example a sol-gel-process.

In the above described embodiments the active layer consist of a piezoelectric material. Nevertheless it is also possible to use other active materials for the manufacturing of the active layer as for example a ferroelectric material, a piezoelectric material, a magnetostrictive material, an electrostrictive material or a memory metal alloy. Magnetostrictive materials for example can be formed on the basis of Lanthanit-ferrum-alloys as for example Terfenol or Terfenol-D, and electrostrictive materials can for example be formed on the basis of Lead-magnesium-niobate as for example PMN or Lanthanum-circonate-titanate as for example PLZT. These materials can be employed in the same manner as in the above described embodiments thus forming the active layer formed according to the present invention. Further information concerning appropriate active materials can be obtained from the PhD-thesis “Ein Beitrag zur Untersuchung von Bimorphspiegeln für die Präzisionsoptik”, by Timo Richard Möller, published in Shaker Verlag 2002, ISBN 3-8322-0555-1.

While the invention has been described also with respect to certain specific embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

Summarized, described herein is a mirror arrangement for reflecting electromagnetic radiation, the mirror arrangement comprising: a substrate having a mirror side facing towards the radiation to be reflected and a back side opposite to the mirror side, wherein a mirror surface is provided on the mirror side and wherein an actuator arrangement for generating a deformation of the substrate is mounted on the back side of the substrate, wherein the actuator arrangement comprises at least one active layer having an areal adhering contact with a portion of the back side of the substrate; wherein the at least one active layer has a first layer thickness at a first location within the portion and a second layer thickness at a second location disposed at a distance from the first location within the portion, wherein the first layer thickness differs from the second layer thickness by more than 1%; and wherein the at least one active layer comprises at least one of a ferroelectric material, a piezoelectric material, a magnetostrictive material, an electrostrictive material and a memory metal alloy.

1. A mirror arrangement for reflecting electromagnetic radiation, the mirror arrangement comprising:
a substrate having a mirror side facing towards the radiation to be reflected and a back side opposite to the mirror side, wherein a mirror surface is provided on the mirror side and wherein an actuator arrangement for generating a deformation of the substrate is mounted on the back side of the substrate, wherein the actuator arrangement comprises at least one active layer having an areal adhering contact with a portion of the back side of the substrate;
wherein the at least one active layer has a first layer thickness at a first location within the portion and a second layer thickness at a second location disposed at a distance from the first location within the portion, wherein the first layer thickness differs from the second layer thickness by more than 1%; and
wherein the at least one active layer comprises at least one of a ferroelectric material, a piezoelectric material, a magnetostrictive material, an electrostrictive material and a memory metal alloy.

2. The mirror arrangement according to claim 1, wherein the first layer thickness differs from the second layer thickness by more than at least one of 2%, 3%, 4%, 5%, 6%, 7%, 8%, 9%, 10%, 11%, 12%, 13%, 14%, and 15%.

3. The mirror arrangement according to claim 1, wherein the at least one active layer has a distribution of the layer thickness which is rotationally symmetric with respect to an axis of symmetry.

4. The mirror arrangement according to claim 1, wherein the at least one active layer has a distribution of the layer thickness, which is, at all locations within the portion, rotationally non-symmetric with respect to all lines extending through each respective location.

5. A mirror arrangement according to claim 4, wherein the distribution of the layer thickness can be represented by substantially one single Zernike polynomial.

6. The mirror arrangement according to claim 1, wherein the substrate has a first substrate thickness at the first location within the portion and a second substrate thickness at the second location within the portion, and wherein the first substrate thickness differs from the second substrate thickness by more than 1%.

7. The mirror arrangement according to claim 6, wherein the first substrate thickness differs from the second substrate thickness by more than at least one of 2%, 3%, 4%, 5%, 6%, 7%, 8%, 9%, 10%, 11%, 12%, 13%, 14%, and 15%.

8. The mirror arrangement according to claim 1, wherein the actuator arrangement comprises one single active layer, wherein the areal adhering contact of the active layer with the portion of the back side of the substrate is mediated by an intermediate adhesion layer firmly joining the active layer to the back side of the substrate.

9. The mirror arrangement according to claim 8, wherein an electrode layer for exciting the active layer is disposed between the active layer and the substrate.

10. The mirror arrangement according to claim 9, wherein the electrode layer comprises the adhesion mediating layer.

11. The mirror arrangement according to claim 9, wherein the electrode layer continuously extends over the portion of the back side of the substrate.

12. The mirror arrangement according to claim 1, wherein the actuator arrangement comprises a plurality of active layers which are stacked one above the other, wherein each pair of active layers are joined to each other by an areal adhering contact.

13. The mirror arrangement according to claim 12, comprising a bottom layer of the plurality of active layers and arranged closest to the substrate, wherein the areal adhering contact of the bottom active layer with the portion of the back side of the substrate is mediated by an intermediate adhesion layer firmly joining the active layer to the back side of the substrate.

14. The mirror arrangement according to claim 13, wherein an electrode layer for exciting the active layer is disposed between the bottom active layer and the substrate.

15. The mirror arrangement according to claim 14, wherein the electrode layer comprises the adhesion mediating layer.

16. The mirror arrangement according to claim 12, wherein at least one electrode layer for exciting at least one active layer of a pair of adjacent layers is disposed between said pair of adjacent active layers.

17. The mirror arrangement according to claim 14, wherein the electrode layer continuously extends over the portion of the back side of the substrate.

18. The mirror arrangement according to claim 14, wherein the electrode layer comprises a plurality of non-overlapping partial electrodes, distributed over the portion of the back side of the substrate.

19. The mirror arrangement according to claim 18, wherein first and second partial electrodes of each pair of partial electrodes are electrically insulated from each other.

20. The mirror arrangement according to claim 18, wherein an electrical resistance between first and second partial electrodes of each pair of partial electrodes is greater than 1 M Ω.

21. The mirror arrangement according to claim 18, wherein the plurality of partial electrodes are arranged in a hexagonal pattern.

22. The mirror arrangement according to claim 19, wherein the plurality of partial electrodes is groupable into electrode groups, wherein the electrode groups are arranged in a hexagonal pattern.

23. A method of manufacturing a mirror arrangement for reflecting electromagnetic radiation, the method comprising:
applying a paste of a precursor material to a back side of a substrate and distributing the precursor material on the back side to form a layer such that the layer has a first layer thickness at a first location and a second layer thickness at a second location disposed at a distance from the first location, wherein the first layer thickness differs from the second layer thickness by more than 1%;
sintering the layer of the precursor material to form an active layer; and
providing a mirror surface on a front side opposite to the back side of the substrate.

24. The method according to claim 23, wherein the distributing of the precursor material comprises rotating of the substrate about an axis of rotation.

25. The method according to claim 23, wherein the distributing of the precursor material comprises pressing a shaped stamp into the layer to shape the layer according to a surface shape of the stamp.

26. The method according to claim 25, wherein the surface shape of the stamp comprises at least one of a concave portion and a convex portion.

27. The method according to claim 26, wherein the surface shape of the stamp comprises at least one of plural concave portions and plural convex portions.

28. An optical system having a plurality of optical elements, wherein at least one of the optical elements comprises a mirror arrangement according to claim 1.

29. An optical system having a plurality of optical elements, wherein at least one of the optical element comprises a mirror arrangement for reflecting electromagnetic radiation, the mirror arrangement comprising:
a substrate having a mirror side facing towards the radiation to be reflected and a back side opposite to the mirror side, wherein a mirror surface is provided on the mirror side and wherein an actuator arrangement for generating a deformation of the substrate is mounted on the back side of the substrate, wherein the actuator arrangement comprises at least one active layer having an areal adhering contact with a portion of the back side of the substrate;
wherein the at least one active layer has a first layer thickness at a first location within the portion and a second layer thickness at a second location disposed at a distance from the first location within the portion, wherein the first layer thickness differs from the second layer thickness by more than 1%; and
wherein the at least one active layer comprises at least one of a ferroelectric material, a piezoelectric material, a magnetostrictive material, an electrostrictive material and a memory metal alloy.

30. The optical system according to claim 29, wherein at least one of the optical elements comprises a refractive lens.

31. The optical system according to claim 29, wherein the system comprises only mirrors as the optical elements.

32. The optical system according to claim 29, further comprising a mount for mounting a patterning structure to be imaged in a region of an object plane of the optical system, and a mount for mounting a substrate having a radiation sensitive layer in an image plane of the optical system.

33. A lithographic method of manufacturing a miniaturized device using a projection exposure system, the method comprising:
disposing a patterning structure to be imaged in a region of an object plane of an imaging optics of the projection exposure system;
disposing a substrate carrying a resist in a region of an image plane of the imaging optics and exposing portions of the substrate with images of the patterning structure using the projection exposure system;
wherein the projection exposure system comprises a plurality of optical elements, and wherein at least one of the optical elements comprises a mirror arrangement according to claim 1.
